(19) United States
(12) Patent Application Publication
(10) Pub. No.: US 2014/0100795 A1
(43) Pub. Date: Apr. 10, 2014

(54) METHOD FOR DETERMINING QUANTITATIVE COMPOSITION OF A MULTI-COMPONENT MEDIUM

(71) Applicant: SCHLUMBERGER TECHNOLOGY CORPORATION, (unknown)

(72) Inventors: ALEXANDER NIKOLAEVICH NADEEV, MOSCOW (RU); DMITRY ALEXANDROVICH KOROBKOV, MOSCOW (RU); OLEG YURIEVICH DINARIEV, MOSCOW (RU); DMITRY EVGENYEVICH MIKLASHEVSKY, KALUGA (RU)

(73) Assignee: SCHLUMBERGER TECHNOLOGY CORPORATION

(21) Appl. No.: 14/049,699

(22) Filed: Oct. 9, 2013

(30) Foreign Application Priority Data
Oct. 10, 2012 (RU) 2012143226

(51) Int. Cl. G01N 5/00

(52) U.S. Cl. CPC G01N 5/00
USPC 702/23

(57) ABSTRACT

Methods for determining a quantitative composition of a multi-component medium comprising at least two known immiscible components comprises determining temperature dependencies of specific heat capacity of each of the components. A sample of the multi-component medium is weighed. Specific heat capacity of the sample is determined at least at i−1 temperature levels, where i is the number of components of the multi-component medium. On the basis of the results from determination of specific heat capacity of the components and the temperature dependencies of specific heat capacity of the components, weight coefficients are calculated for each component of the medium. Quantitative content of each of the components of the multi-component medium is determined on the basis of the obtained values of the weight coefficients of the components.

### CROSS-REFERENCE TO RELATED APPLICATION

This application claims priority to Russian Patent Application No. 2012143226 filed Oct. 10, 2012, which is incorporated herein by reference in its entirety.

### FIELD

The subject disclosure relates to studying the composition of liquids and materials comprising two or more components, in particular, to methods of determining quantitative compositions of multi-component media.

### BACKGROUND

For solving many scientific and technological problems, it is required to determine quantitative compositions of multi-component materials, for example, in the oil and gas industry—mineral composition of rocks as well as types of fluids contained in the rock (water solutions of salts, oils, etc.). Information of this kind is useful for characterization of an oil and/or gas bearing formation and for modeling of rock properties and fluid flow: geomechanical parameters, phase permeabilities, displacement efficiency, etc.

One of the traditional approaches to mineral identification is a powder X-ray diffraction method:
(http://serc.carleton.edu/research_education/geochemsheets/techniques/XRD.html)
   In comparison with other methods of analysis, this method makes it possible to rapidly and reliably determine composition of multi-component mixtures. Quantitative determination of mineral content may also be determined using the thin section petrographic analysis, X-ray fluorescent analysis or confocal Raman electronic microscopy. Disadvantages of these methods include local (2D) character of sample investigation, high error level, impossibility of or inadaptability for studying media with residual saturation with fluids, and the necessity of special preparation of a sample, which often results in destruction of the original structure of material. For instance, examining using X-ray diffraction, it is necessary to sample the medium as a powder in order to obtain isotropic dispersion of X-rays on crystalline structure of the sample. Examination of amorphous or nanocrystalline media with the use of powder X-ray diffraction is difficult.

### SUMMARY

The subject disclosure provides a method for determining quantitative composition of a multi-component medium with high accuracy and without destruction of a sample. With known porosity, the proposed method makes it possible to determine saturation of a material with various fluids.

In accordance with the proposed method for determining a quantitative composition of a multi-component medium, temperature dependencies of specific heat capacity of each of the components of the multi-component medium are determined, the medium comprises at least two known immiscible components. A sample of the medium is weighed. Specific heat capacity of the sample of the multi-component medium is determined at least at i−1 temperature levels, where i is a number of the components of the multi-component medium. On the basis of the results of determining specific heat capacity at different temperatures and the temperature dependencies of specific heat capacity of the components, weight coefficients are calculated for each component of the medium and a quantitative content of each of the components of the multi-component medium is determined on the basis of the obtained values of the weight coefficients.

The multi-component medium may be a mixture of gases and/or liquids, or a material saturated by a gas, a liquid or a mixture of gases and/or liquids.

The temperature dependencies of specific heat capacity of each of the components of the multi-component medium are determined by means of measurements or from reference databases.

### BRIEF DESCRIPTION OF THE DRAWING

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 depicts an example of using the temperature dependencies of specific heat capacity for quantitative determination of components of the sample.

### DETAILED DESCRIPTION

In the subject disclosure, a new approach is proposed for determining a quantitative composition of media comprising at least two components.

In an embodiment, a method for studying a multi-component medium comprising at least two components (including but not limited to mono- or polymineral matrix, pores, various proportions of components (water/oil/gas)) with application of modern high-accuracy methods for measurement of heat capacity at various temperatures.

A specific heat capacity of a solid material or a liquid is a quantity of energy (heat) required to increase temperature of a unit mass of this material by one degree Kelvin and can be expressed by the following equation:

$${C}_{p} = \frac{Δ Q}{M Δ T} , \qquad ( 1 )$$

where Cₚ is a specific heat capacity at constant pressure, ΔQ is a quantity of energy (heat) transferred to the material, M is mass of the material, ΔT is change in temperature.

Specific heat capacity depends on thermodynamic conditions, for example, on temperature itself, and on pressure. Specific heat capacity is an extensive value. This means that a measured value of specific heat capacity of a material or a liquid comprising at least two components can be expressed by a linear combination of values of specific heat capacity of each of its components:

$${C}_{p} ( {T}_{exp} ) = {\sum }_{i} {α}_{i} {C}_{pi} ( {T}_{exp} ) , \qquad ( 2 )$$

where Cₚ(Tₑₓₚ) is specific heat capacity of the material, Cₚᵢ(Tₑₓₚ) is specific heat capacity of an ith component (including but not limited to minerals, fluids, etc.), Tₑₓₚ is experimental temperature, αᵢ is a weight coefficient of the ith component of the material.

The normalizing equation for weight coefficients of contents of components has the following form:

$${\sum }_{i} {α}_{i} = {\sum }_{i} \frac{{m}_{i}}{M} = 1 \qquad ( 3 )$$

where mᵢ is a mass of the ith component of the material. Using temperature dependence for each of the components makes it possible to determine weight coefficients (αᵢ) as a result of conducting i−1 experiments at different temperatures (Tₑₓₚ), where i is a number of components having significant weight coefficient and significant values of specific heat capacities. Weight coefficients express ratio of components for a particular material and are equal to mass of ith component (mᵢ) in total mass of the material (M).

The proposed method is realized in the following way. Prior to start of measurements, a sample of a multi-component medium—for example, a mixture comprising at least two known immiscible components (a sample of material saturated by a gas, liquid or a mixture of gases and/or liquids or a sample of a mixture of gases and/or liquids)—is weighed. A preliminary component analysis of the sample, for example, minerals encountered in a certain type of rock, should be known before the start of examination or should be determined with the use of a less accurate method.

Temperature dependences of specific heat capacity of each of the components of the multi-component medium are determined by means of measurements or from reference databases.

Measurements of specific heat capacity are conducted at various temperatures (Tₑₓₚ); number of measurements depends on a number of components and is not less than i−1, where i is the number of components having significant weight coefficients. Thus, it is necessary to conduct measurements at not less than i−1 levels of stabilized temperature for one and the same multi-component mixture of materials or a mixture of liquids or a mixture of gases and liquids.

Weight coefficients of components of the mixture are calculated on the basis of measurements of specific heat capacity at different temperatures and temperature dependences of specific heat capacity for different components of the mixture with the use of Equations (2) and (3), where equations of type (2) for different temperatures determine the relationship between measured heat capacity of the sample under examination and heat capacity of its components through weight coefficients, which are ratios of a quantity of the component under determination to the total mass of the sample. Number of measurements at different temperatures, i.e., number of equations, depends on the number of components. Equation (3) is the normalizing equation on weight coefficients, which makes it possible to reduce the number of experiments.

A quantitative content of each of the components is determined on the basis of the obtained values of weight coefficients.

To control quality and/or to enhance reliability of determination of composition of the material under examination, data about a density of each of components may be used: the sum of products of density and weight coefficient for all components must equal a density of the sample.

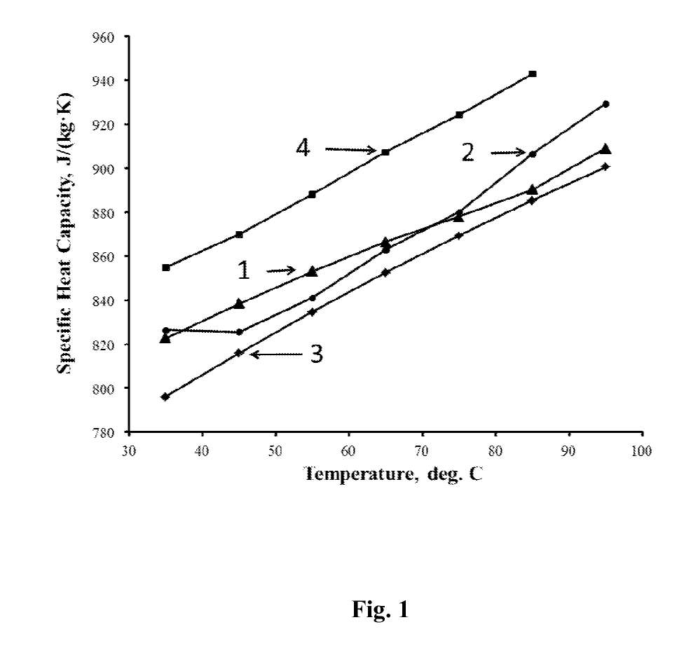

Modern methods (for example, U.S. Publication No. 2009/0154520 A1) provide for precise and reproducible measurements of specific heat capacity. For measurements of dependence of specific heat capacity on temperature, a calorimeter of BT2.15 type (SETARAM®, France, http://www.setaram.com/BT-2.15.htm), or any other calorimeter with close or better metrological characteristics. As an example, measurements were conducted in the temperature range of 30-90° C. with the following parameters: heating rate—0.1° C./min, step of temperature change—10° C., measurements of specific heat capacity at each step with consideration of heating were conducted during 8 hours. FIG. 1 shows temperature curves 1, 2 and 3—temperature dependences of specific heat capacity of components of the theoretical mixture, and curve 4—temperature dependence of specific heat capacity of the theoretic mixture: 51% of corundum, 23.5% of glass-ceramic, 31% of marble, and 4.5% of oil. The table below shows values of specific heat capacity of oil used in the calculation of specific heat capacity of the theoretical mixture at different temperatures.

| | Specific heat capacity, |
|---|---|
| Temperature, ° C. | J/kg · K |
| 35 | 1819.6 |
| 45 | 1860.2 |
| 55 | 1903.6 |
| 65 | 1948.4 |
| 75 | 1991.2 |
| 85 | 2029.5 |

Measurements of heat flow can be performed in a scanning mode as well, i.e., with a constant rate of temperature change of the sample, resulting in reduction of time of the experiment. Values of heat flow toward the sample at the experimental temperature are used for calculation of specific heat capacity by Formula (1).

Using temperature dependences of specific heat capacity for different components makes it possible to calculate the contents of specific heat capacity of the artificial mixture: 51% of corundum, 23% of grass ceramic, 21% of marble, 5% of oil. The weight coefficient for air is about three orders of magnitude lower than that of the other components that is why it is possible to neglect it. The experimental curve for the artificial mixture is presented in FIG. 1, curve 4.

The system of equations (2) for experimental values of specific heat capacity at different temperatures of the above-described artificial mixture has the following form:

$$\{ \begin{matrix}{C}_{p} ( 35 ° C . ) = {α}_{1} {C}_{{p}_{1}} ( 35 ° C . ) + {α}_{2} {C}_{{p}_{2}} ( 35 ° C . ) + {α}_{3} {C}_{{p}_{3}} ( 35 ° C . ) + {α}_{4} {C}_{{p}_{4}} ( 35 ° C . ) \\ {C}_{p} ( 45 ° C . ) = {α}_{1} {C}_{{p}_{1}} ( 45 ° C . ) + {α}_{2} {C}_{{p}_{2}} ( 45 ° C . ) + {α}_{3} {C}_{{p}_{3}} ( 45 ° C . ) + {α}_{4} {C}_{{p}_{4}} ( 45 ° C . ) \\ {C}_{p} ( 55 ° C . ) = {α}_{1} {C}_{{p}_{1}} ( 55 ° C . ) + {α}_{2} {C}_{{p}_{2}} ( 55 ° C . ) + {α}_{3} {C}_{{p}_{3}} ( 55 ° C . ) + {α}_{4} {C}_{{p}_{4}} ( 55 ° C . ) \\ {C}_{p} ( 65 ° C . ) = {α}_{1} {C}_{{p}_{1}} ( 65 ° C . ) + {α}_{2} {C}_{{p}_{2}} ( 65 ° C . ) + {α}_{3} {C}_{{p}_{3}} ( 65 ° C . ) + {α}_{4} {C}_{{p}_{4}} ( 65 ° C . )\end{matrix} \qquad ( 4 )$$

where α₁, α₂, α₃, α₄ are weight coefficients for corundum, glass ceramic, marble and oil, respectively, and Cₚ₁, Cₚ₂, Cₚ₃, Cₚ₄ are specific heat capacities for corundum, glass ceramic, marble and oil, respectively.

Methods for solving such systems of linear equations are widely known (http://joshua.smcvt.edu/linearalgebra/book.pdf). The calculated weight coefficients: α₁=0.51, α₂=0.23, α₃=0.21, α₄=0.05 coincide with the parameters of the artificial mixture.

1. A method for determining a quantitative composition of a multi-component medium, comprising:
determining temperature dependencies of specific heat capacity of each component of the multi-component medium, the medium comprising at least two known immiscible components,
weighing a sample of the medium,
determining specific heat capacity of the sample of the multi-component medium at least at i−1 temperature levels, where i is a number of the components of the multi-component medium,
calculating weight coefficients for each component of the medium on the basis of results of determining specific heat capacity at different temperatures and the temperature dependences of specific heat capacity of the components, and
determining a quantitative content of each of the components of the multi-component medium on the basis of the obtained weight coefficients of the components.

2. The method of claim 1, wherein the multi-component medium is a material saturated with a gas.

3. The method of claim 1, wherein the multi-component medium is a material saturated with a liquid.

4. The method of claim 1, wherein the multi-component medium is a material saturated with a mixture of gases.

5. The method of claim 1, wherein the multi-component medium is a material saturated with a mixture of liquids.

6. The method of claim 1, wherein the multi-component medium is a material saturated with a mixture of gases and liquids.

7. The method of claim 1, wherein the multi-component medium is a mixture of gases.

8. The method of claim 1, wherein the multi-component medium is a mixture of liquids.

9. The method of claim 1, wherein the multi-component medium is a mixture of gases and liquids.

10. The method of claim 1, wherein the temperature dependencies of each component of the multi-component medium is determined by means of measurements.

11. The method of claim 1, wherein the temperature dependences of each component of the multi-component medium is determined from reference databases.

12. The method of claim 1, wherein the specific heat capacity of a sample of multi-component medium is determined by measuring a heat flow toward the sample placed in a calorimeter.

13. The method of claim 1, wherein the change in temperature and measurement of heat flow at each temperature level is made step-by-step.

14. The method of claim 1, wherein the temperature changes and measurements of heat flow are made continuously.
